(19) United States
(12) Patent Application Publication
(10) Pub. No.: US 2008/0201257 A1
(43) Pub. Date: Aug. 21, 2008

(54) ALTERNATIVE METHOD AND SYSTEM FOR LEASING, FINANCING AND PURCHASING RESIDENTIAL REAL ESTATE

(76) Inventors: Darryl Lewis, Shoreline, WA (US); Karim Khoury, Everett, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/675,543

(22) Filed: Feb. 15, 2007

(51) Int. Cl. G06Q 40/00

(52) U.S. Cl. 705/38

(57) ABSTRACT

The present invention is directed to a method and system for allowing a customer to purchase a house at an affordable price, where the house has been leased to the consumer under mutually agreed terms between the consumer and a leasing company. More specifically, the method and system facilitates a financial service alternative to conventional financial services, which enables a consumer first to select a house to lease and then optionally to purchase the leased house at a fixed residual purchase price during or at the end of the lease term. The consumer is directed to select a market available “for sale” residential real property to be leased. The selected house is initially purchased by a home leasing company for providing the alternative financial service on the selected house. The residual purchase price is determined based on the acquisition cost plus an appreciation factor based on lease terms and qualifications of the consumer.

### BACKGROUND

In recent years, economic and political factors, such as increasing interest rates, strong economic growth, and increased demand from an ever increasing population, have caused housing prices to soar, in many areas of the country, well beyond what those people with median family incomes can afford. This market phenomenon has resulted in the generation of “exotic” financing models by mortgage companies in an attempt to keep housing affordable. Some of those financing products include the negative amortization, adjustable rate mortgages, the 40- and 50-year amortizing mortgage, and interest-only products. The financiers, by offering such exotic financing products, attempt to make a home affordable in the short-term, but leave uncertainty for consumers in the long term. Such financing products can subject homeowners to intermediate and long-term risk of high monthly payments as interest rates rise and/or rates adjust above introductory discounts thereby increasing the risk of default and foreclosure. Further, many homeowners with exotic financing cannot enjoy the return from investment on their homes, because many of these products place the homeowners at significant risk for default and provide limited options for consumers who need to sell their home after a short holding period.

Alternatively, the existing residential leasing market only provides available “for rent” product that is made up of existing inventory that is tied to specific rental locations. Consumers are limited to selecting from apartment complexes and hard to find single family residential real properties. In this manner, consumers are forced to choose from available product that may not fit their needs because a ‘rental home’ with the preferred characteristics is not available. Further, with the existing ‘for rent’ inventory, consumers are described as renters because of the complexes where they live. In this manner, affordability may not be the issue. Many renters are lifelong renters that do not desire to become homeowners. In this case, the ability to select a home from a larger pool of inventory that includes “for sale” product for a long-term lease would be desirable.

One solution for making a home more affordable and reducing long-term risk is the utilization of a special housing lease model such as a “lease to own” or “rent to own” model. Generally, under the “lease-to-own” model, an individual landlord leases a property to the lessee with an option to purchase the leased property at the end of the lease term. In this way, the lessee can typically utilize a portion of the rental payment toward purchasing the leased property. Some institutionalized “lease-to-own” programs have also been developed by not-for-profit and governmental sponsored agencies to help low-income families. Despite the many benefits, including affordable monthly payments, many potential home buyers are not fond of the current lease-to-own programs because the existing rental markets or affordable housing developments dictate the terms of leases and the inventory available for lease. For example, the current “lease-to-own” model has a very inflexible market (only a small part of the rental market, which is itself a fraction of the residential real estate market), thus the consumer has very few residential property choices. Additionally, finding a home available for lease-to-own is difficult and the terms of such agreements are not standardized, but left at the will of the property owner placing the consumer at risk. The current lease-to-own model restricts the ability of the consumer to modify or upgrade the leased property to suit their needs because of the consumer's uncertainty over possible loss of the money invested in the upgrade. Further, the current lease-to-own model often charges steep option fees and option pricing for the home is not typically fixed, but is based on appraised value or some other market pricing.

Accordingly, there is a need to provide an alternative financing method for a flexible residential real property lease and purchase model which provides consumers with the ability to select a market-available home with an affordable payment plan that is less likely to subject homeowners to potential financial risk and that enables greater flexibility in the choice of product.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an aspect of the present invention, a method is provided for a financing service which enables a consumer to lease a residential real property with a residual purchase price. The method includes allowing a consumer to select a residential real property for the service and receiving, from the consumer, information about the selected residential real property for the service. Information about the consumer is reviewed similar to mortgage application to determine qualification. The information about the selected residential real property is evaluated by a home leasing company in order to determine a financing and purchasing decision. The home leasing company and the consumer sign an agreement with respect to the selected residential real property, which specifies terms and conditions for the service along with the residual purchase price. Upon receipt of the agreement, the home leasing company purchases the selected residential real property in which the consumer will live. At the end of the lease, the home leasing company offers to the consumer the option to re-lease the selected residential property, purchase the property for the residual purchase price, or to turn the property back to the home leasing company. If the consumer opts to purchase, the home leasing company and the consumer finalize the transfer of the selected residential real property. The home leasing company then transfers the title of the selected residential real property to the consumer.

In accordance with another aspect of the present invention, an alternative financing service system is provided for allowing a consumer to lease a residential real property with a residual purchase price where the residential real property has been leased to the consumer. Importantly, the consumer has selected the residential real property for the alternative financing service. The alternative financing service system comprises a broker component, an evaluation component, and a decision component. The broker component receives a request for service from a consumer, and receives from the consumer, personal credit application information along with information about a selected residential real property. The evaluation component evaluates the information about the selected residential real property and makes a credit qualifying decision in order to determine a financing and purchasing decision. The decision component determines a purchasing and financing decision, and prepares a service agreement, the agreement specifying terms and conditions for the service, along with a residual purchase price. When the decision component detects a triggering event, such as the end of the lease term, the decision component notifies the consumer about the end of lease options, including the purchase option for the selected residential real property, along with their options to re-lease and vacate the property. The alternative financing service system further comprises an information retrieval component for obtaining user profile information and a set of rules and criteria for the service.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of an exemplary networked environment suitable for providing alternative financing and purchasing services in accordance with an aspect of the present invention;

FIG. 2 is a block diagram illustrative of relationships among entities related to alternative financing and purchasing services in accordance with an embodiment of the present invention;

FIG. 3 is a block diagram depicting components of the service server in accordance with an embodiment of the present invention;

FIG. 4 is a flow diagram depicting a routine for an alternative financing and purchasing service in accordance with an embodiment of the present invention;

FIG. 5 is a flow diagram depicting a pre-approval subroutine utilized by the routine in FIG. 4;

FIG. 6 is an exemplary table showing a rate sheet used by a broker and a sales person in accordance with an embodiment of the present invention;

FIG. 7 is a flow diagram depicting another routine for an alternative financing and purchasing service in accordance with an embodiment of the present invention;

FIG. 8 is a flow diagram depicting a routine for the end of a lease period allowing a customer to purchase for the residual purchase price, re-lease the property or vacate for a leased real property in accordance with an embodiment of the present invention; and

FIG. 9 is a flow diagram depicting another routine for an alternative financing and purchasing service on residential real properties provided by affiliated developers in accordance with an embodiment of the present invention.

### DETAILED DESCRIPTION

Generally described, embodiments of the present invention relate to a method and system for allowing a consumer to purchase a residential real property at an affordable price, where the residential real property will first be leased to the consumer under mutually agreed terms between the consumer and the leasing company. More specifically, the method and system facilitates an alternative financial service for a consumer to first lease a residential real property which has been selected by the consumer, and then eventually to purchase the leased residential real property at a stated residual purchase price. The method and system allows the flexibility of a lease without the restrictions commonly required by conventional lease-to-own projects, but still enables the consumer to opt to purchase after an agreed upon period for an agreed upon price.

In the following description, numerous specific details are set forth in order to provide a thorough understanding of the invention. However, it will be apparent to one skilled in the art that the invention may be practiced without some or all of these specific details. In other instances, well-known process steps have not been described in detail in order not to obscure the invention.

The following detailed description describes exemplary embodiments of the invention. Although specific system configurations and flow diagrams are illustrated, it should be understood that the examples provided are not exhaustive and do not limit the present invention to the precise forms and embodiments disclosed. It should also be understood that the following description is presented largely in terms of logic operations that may be performed by conventional computer components. These computer components, which may be grouped at a single location or distributed over a wide area on a plurality of devices, generally include computer processors, memory storage devices, display devices, input devices, etc. In circumstances where the computer components are distributed, the computer components are accessible to each other via communication links.

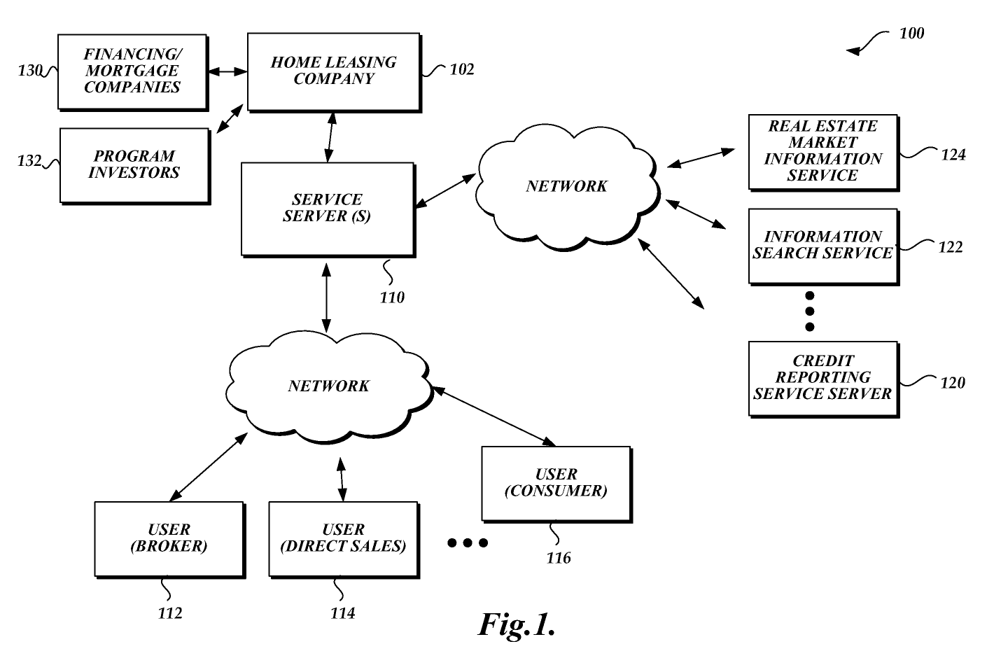

Referring to FIG. 1, a block diagram illustrates an exemplary networked environment 100 suitable for facilitating alternative financing services for purchasing leased residential real properties in accordance with embodiments of the present invention.

The exemplary networked environment 100 includes one or more service servers, such as a service server 110 for providing users with services related to “equity leasing” residential real properties and for assisting a home leasing company to evaluate residential real properties, and to make decisions to provide such service to a particular customer. An “equity leasing” service, as used herein, refers to an alternative financing service that allows a consumer to choose a residential real property to lease with a residual purchase price. In the “equity leasing” service, a consumer has the choice to either purchase the home at the residual purchase price or return the home to the lessor at the end of the lease period.

More specifically, the “equity leasing” service utilizes a trend that residential properties generally appreciate over time, and thus, residual values in real estate generate large revenue streams due to property appreciation. Further, by utilizing the appreciated value of residential properties, monthly housing payments can be offered at below-standard mortgage rates, thereby improving affordability. Due to this low monthly payment and the consumer's ability to select the property, default rates may be mitigated. The home leasing company may determine an appropriate program for a consumer based on the consumer's income, credit, and job stability; similar to mortgage qualification.

In one embodiment, within the exemplary networked environment 100, the service server 110 is configured to obtain information from other service providers, such as a real estate market information service provider 124, information search service provider 122, credit reporting service provider 120, etc. The service server 110 is also configured to provide the obtained information to the home leasing company 102 and/or several users such as users 112, 114, 116. In one embodiment, the users 112, 114, 116 may be any type of users who can utilize the service server 110 in order to obtain or provide “equity leasing” services of the home leasing company. For example, a broker 112, a direct sales person 114 of the home leasing company 102, and a consumer 116 who is interested in the leasing services offered by the home leasing company 102 may be users of the service server 110. As will be readily appreciated by one of ordinary skill in the art, each user 112, 114, 116 may use user devices (not shown) by which the user can obtain information relevant to the leasing service directly or indirectly from the service server 110. In one embodiment, the service server 110 may provide a front end interface through which each user device can communicate with the home leasing company 102 and access other service servers 124, 122, 120 over a network, for example, the Internet. Alternatively, the front end interface of the service server 110 may allow user devices to communicate with various financing/mortgage companies 130 and/or program investors 132. As will be appreciated by one of ordinary skill in the art, the user devices are typically computing devices including a variety of configurations or forms such as, but not limited to, laptop or tablet computers, personal computers, personal digital assistants (PDAs), hybrid PDA/mobile phones, mobile phones, wired landline phones, and the like. While illustrative embodiments have been illustrated and described, it will be appreciated that various changes can be made therein without departing from the spirit and scope of the invention.

Those skilled in the art will appreciate that the various components depicted in FIG. 1 are illustrative only. As mentioned above, an actual embodiment of a service server 110 may be comprised of a single computer or a plurality of discrete, cooperative servers distributed in a communications network or connected through the Internet. Similarly, the identified components should be viewed as logical components as each component may be physically embodied on one or more computer systems as well as combined with other hardware and/or software components not illustrated herein.

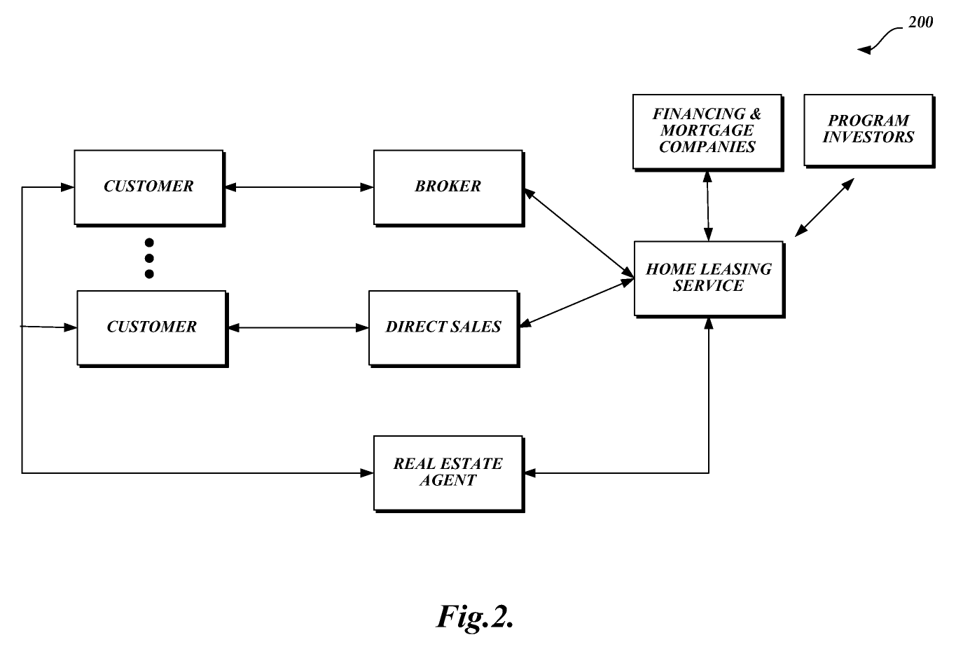

FIG. 2 is a block diagram illustrative of relationships among entities related to the “equity leasing” services in accordance with an embodiment of the present invention.

In one embodiment, the “equity leasing” services may be provided or offered through a distribution channel of mortgage brokers (brokers) who are affiliated with the home leasing company. In some instances, existing residential mortgage channels may be utilized for the distribution channel and thus it may not be necessary to create a new distribution channel of brokers for the “equity leasing” services. The “equity leasing” services offered by the brokers may be centrally underwritten by the home leasing company. In this embodiment, a consumer may initially contact a broker to apply for an “equity leasing” service. The broker may negotiate with the consumer to determine an appropriate program based on the consumer's current financial situation (e.g., income, credit, and job stability similar to mortgage qualification). Based on guidelines, rules and criteria provided by the home leasing company, various terms, such as a maximum value of a residential real property, exclusion or inclusion of a specific area, estimated monthly lease payment range, minimum lease term, etc., may also be preliminarily determined. As will be discussed in greater detail below, the guidelines, rules and criteria may be stored in the service server 110 and the broker may request such information from the service server 110 to determine an appropriate program. In an alternative embodiment, the broker may submit relevant information to the service server 110 which automatically determines an appropriate program for the customer by applying the stored guidelines, rules and criteria. Subsequently, the user reviews the determined program and is able to negotiate with the broker until the acceptable program is mutually agreed.

The agreed program may be forwarded to the home leasing company which further retrieves more information through the service server 110 in order to evaluate the agreed program and pre-approves the terms and conditions specified in the agreed program. Upon receipt of a pre-approval, the consumer then can select a residential real property, with help from a real estate agent if they so choose, to be leased through the home leasing company in accordance with the pre-approved program. The real estate agent assisting the consumer in fact represents the home leasing company for the purchase of a residential real property since the home leasing company, not the consumer, purchases the residential real property chosen by the consumer. After the consumer selects a residential real property, the real estate agent prepares a purchase agreement on behalf of the home leasing company and submits it to the corresponding broker. The home leasing company may determine whether the selected residential real property is to be purchased and leased to the consumer and what source of financing from its financing and mortgage companies or program investors that would be appropriate for the purchase of the selected residential real property. The home leasing company reviews and then approves the final purchase agreement.

Upon receipt of approval on the selected residential real property, the broker may calculate a monthly lease payment for the selected residential real property based on current lease factor (i.e., interest rate in a typical residential mortgage), residual purchase price (i.e., price to purchase the residential real property at the end of the lease term), estimated acquisition price, pre-approved terms and the like. The consumer and the home leasing company sign a lease contract for the selected residential real property. Subsequently, the home leasing company purchases the selected residential real property and allows the consumer to move in. Generally, the home leasing company will utilize financing provided by a third party financing/mortgage company or a program investor to purchase the selected residential real property. Individual financing for specific homes or large lines of credit for purchasing may typically be utilized by the home leasing company for its acquisitions.

In an alternative embodiment, a direct salesperson of the home leasing company may play a broker role and communicate with the consumer. Further, the consumer may consider a recommendation on available residential real properties by the home leasing company, for example, residential real properties owned by the home leasing company, market available homes for sale or residential real properties built by builders affiliated with the home leasing company.

At some time before the lease term expires, the home leasing company notifies the consumer of their end of lease options or may offer incentives for the consumer to purchase the property prior to the end of the lease. In this manner, the leased residential real property may be offered for sale to the consumer. For example, three months before the end of the lease term, the consumer may be notified about their residual purchase price and option to purchase the leased residential real property. For another example, if the housing market is strong and thus the appreciated value of the residential real property is greater than the projected appreciated value, the home leasing company may allow the consumer to purchase the residential real property before the end of the lease term without any penalty. It is to be noted that the consumer can purchase the leased residential real property at the fixed residual purchase price which has been secured in the lease contract, which in highly appreciating markets, will typically be less than the appreciated price of the residential real property after the lease term. However, in some cases the residual purchase price may be equal to the appraised market value at the end of the lease term.

It is to be understood that, through a secured residual purchase price, the “equity leasing” service enables consumers to plan for a purchase at an affordable and secured price. Further, considering that the current housing market's pricing excludes more and more purchasers from the market (as the increase in home prices and interest rates outpaces household incomes), the “equity leasing” services are much more beneficial than the existing alternative, an uncertain future appreciated price for which consumers must save prior to committing to purchase a home. In an important aspect of the present invention, the leased residential real property is chosen by the consumer from the real estate market, not from the rental market, which greatly improves the availability of housing inventory, and lets the consumer purchase a residential real property of his or her choice, at a deferred time. This aspect enables the consumer the option of leasing existing “for sale” residential real properties and thereby provides them greater choice and flexibility in their housing and removes the stigma of rental projects or complexes.

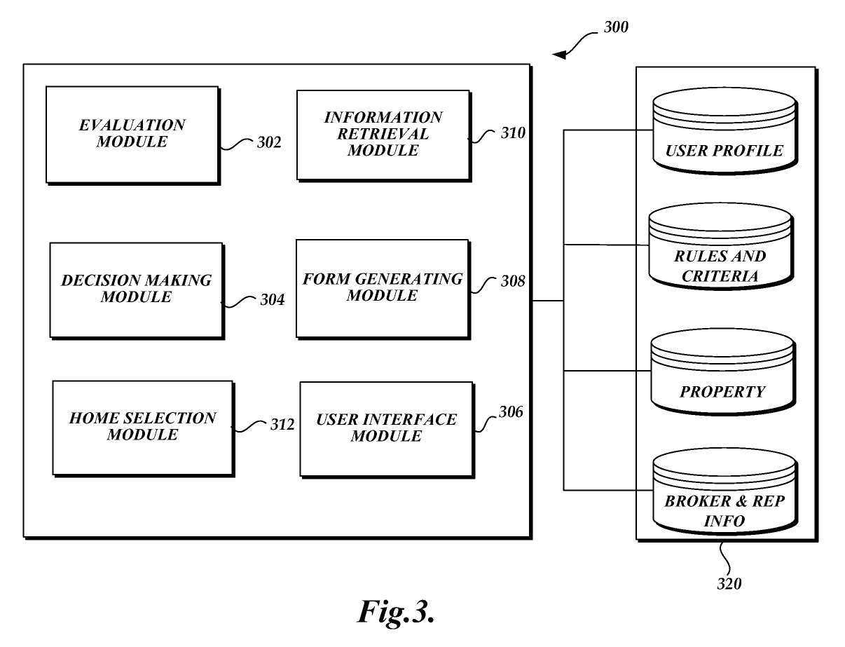

FIG. 3 is a block diagram 300 depicting components of the service server 110 in accordance with an embodiment of the present invention. As shown in FIG. 3, the service server 110 may comprise several software modules, including, but not limited to, an evaluation module 302, an information retrieval module 310, a decision-making module 304, and the like. The evaluation module 302 may be configured to evaluate a lease factor (e.g., interest rate), an appreciation factor, a consumer's credit score, a projected house price (residual purchase price), a special discount, etc. As will be discussed in greater detail below, an appropriate program may be determined according to a credit score, lease factor, appreciation factor and other qualifying factors. The decision-making module 304 is configured to enable mortgage brokers to lock in pricing for the appropriate program, or to assist the home leasing company (or underwriters) to make a decision for approval of the appropriate program. Further, the decision-making module 304 may assist the home leasing company to make a purchasing decision and/or a financing decision. The information retrieval module 310 is configured to obtain and retrieve information relevant to the “equity leasing” service. Some information may be retrieved from a local database 320 or other service providers. The local database 320 may include information about user profile, rules and criteria about the “equity leasing” service, residential properties which are leased to consumers, information about brokers and sales, and the like.

Alternatively a form-generating module 308 and a user interface module 306 may be also included in the service server 110. The form-generating module 308 may be configured to generate lease documents (e.g., a lease contract, a commitment agreement, etc.), purchase documents (a purchase agreement, program investor documents, etc.), a service application, or the like to consummate the transactions related to the “equity leasing” services. The user interface module 306 may be configured to interact with users in order for the service provider to facilitate the “equity leasing” services. Further, the service server 110 may include a database 320 storing user profile information, rules and criteria, leased property information, and broker and sales representative information. Distribution of service may be through any electronic means such as the Internet, direct terminals, PDAs, or similar devices.

A home selection module 312 may provide data for consumers and sales representatives to obtain information on available for lease properties directly from the home leasing company or an affiliate. It may also provide modules for other computer systems to interact with that would produce interactive pricing for a given “for sale” residential real property. A consumer application may be taken with this module. Leads from consumers may be collected and distributed to mortgage brokers, real estate agents and direct sales. Consumers may be able to receive emails or other communication pieces notifying them of available properties that meet their affordability criteria and desired home characteristics. In this manner, the consumer does not have to directly interact with the home selection module 312, but are able to setup a “profile” that will prompt a response in the system automatically.

The home selection module 312 may also work to provide lease pricing to market available residential real property that is marketed for sale by other electronic systems such as the multiple listing service utilized by real estate sales companies. In this case, the module 312 may interface with the third party electronic system to create lease pricing and communicate this lease pricing for publishing. The pricing and home information may be served to end users either through the home selection module 312 or through the third party electronic systems.

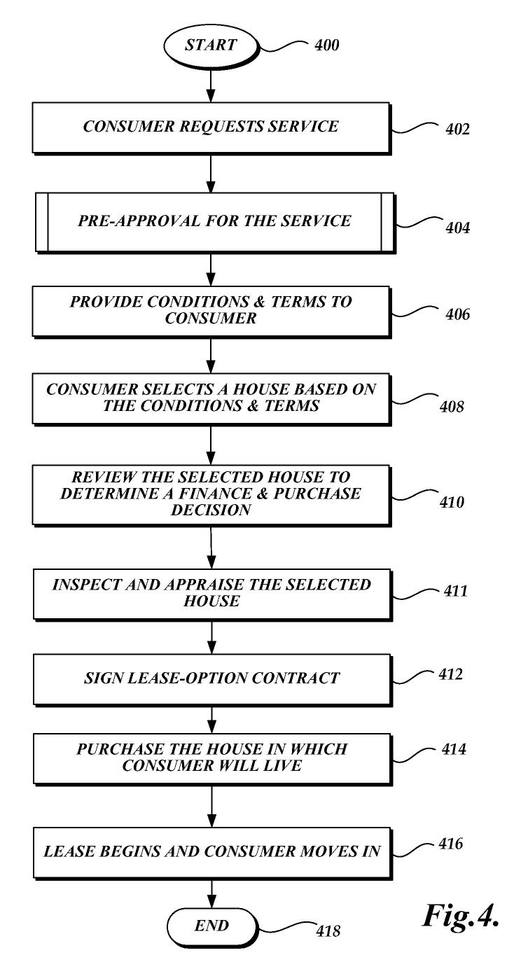

Referring to FIG. 4, a flow diagram depicts a routine for facilitating an alternative financing service in accordance with an embodiment of the present invention. For purpose of discussion, the service server 110, connected with local or remote databases and other service providers via a data network, assists the home leasing company to provide “equity leasing” services to several consumers.

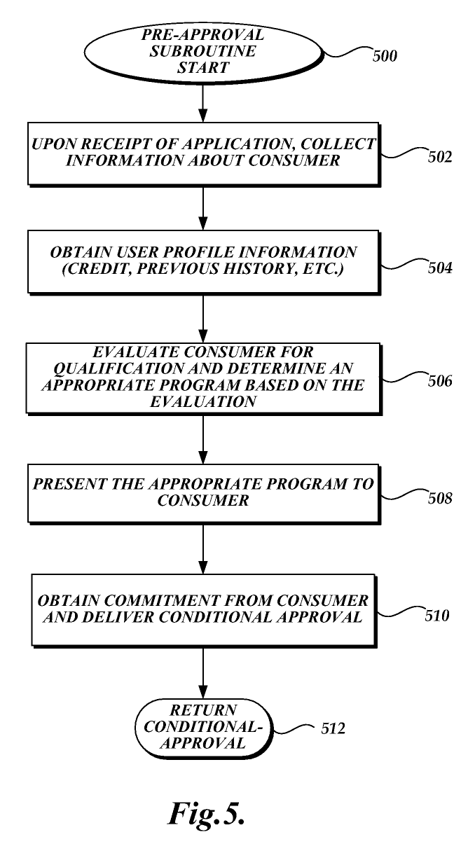

Beginning with block 402, a consumer may request an “equity leasing” service from a broker or a direct sales person or through a computer based lead generator of the home leasing company. As mentioned above, the broker may be a conventional mortgage broker or leasing broker who also sells “equity leasing” programs to consumers. At block 404, a broker may communicate with the home leasing company (an underwriter of the “equity leasing” programs) to obtain a pre-approval for the consumer via subroutine in FIG. 5. Generally, the broker determines an appropriate program tailored for a particular customer's situations and needs. In one embodiment, the service server (more specifically, the evaluation module of the service server) may assist the broker to determine an appropriate program for a particular consumer. The appropriate program may specify preliminary terms and conditions such as a maximum price of a residential real property, a potential geographic area, estimated lease payment range, etc. Eventually, the home leasing company pre-approves the appropriate program. This pre-approval may occur through electronic means as described or when necessary through traditional manual underwriting.

At block 406, the terms and conditions specified in the pre-approval are provided to the consumer directly or through the broker. At block 408, the consumer selects a residential real property for an “equity leasing” service based on the pre-approval. The broker may submit the selected residential real property information along with the consumer's information to the home leasing company via the service server 110. When the consumer selects a residential real property, the consumer may obtain information from the service server 110 or other service providers, about residential real estate properties which are currently on the market. As described above, the consumer may be advised to select a residential real property which meets the conditions and terms of the pre-approval.

At block 410, the home leasing company may review the selected residential real property to determine a financing and purchasing decision. More specifically, the home leasing company may communicate with a third party appraiser, mortgage company, financing company, or program investor regarding the selected residential real property. Further, the home leasing company evaluates the selected residential real property against the terms and conditions of the pre-approval for the consumer. If the selected residential real property does not meet the terms and conditions of the pre-approval, the home leasing company may evaluate risk factors on the selected residential real property in order to determine its purchasing decision. In some instances, if the selected residential real property does not meet the terms and conditions of the pre-approval, the home leasing company may reject the request from the broker and ask to select another residential real property for the review.

After the home leasing company decides to provide the “equity leasing” service on the selected residential real property, at block 411, the home leasing company has the selected residential real property inspected by a qualified home inspector and appraised by a licensed residential real property appraiser to conclude the value of the home. The home inspector completes the property maintenance plan that is a part of the lease contract.

At block 412, the home leasing company and the consumer may sign a lease contract (or commitment agreement) on the selected residential real property. As will be discussed in greater detail below, the lease contract, similar to a conventional lease contract, may specify various terms, including, but not limited to, a lease term, a maintenance schedule, a residual purchase option, a residual purchase price, a remedy for a breach of contract, and the like. The lease term may vary, for example, from 12 months to 60 months. The maintenance schedule may require semi-annual inspections on the lease property by the home leasing company. The residual purchase price may be determined based on the acquisition cost, plus an appreciation factor based on lease terms and qualifications of the lessee.

In one embodiment, based on the housing market and the geographic area conditions, a minimum lease term may be determined so that the home leasing company can maintain lower vacancy losses. Having each consumer responsible for maintenance of the leased residential real property, the leased residential real property can be maintained as if the consumer owns the property. In this manner, the home leasing company does not play a traditional landlord role and thereby allows the consumer to take early ownership of the property. Provided the results of inspection and appraisal are positive, at block 414, the home leasing company purchases the selected residential real property in which to allow the consumer to live. Generally, the home leasing company may get a loan (mortgage) to purchase the selected residential real property or may more often maintain lines of credit of capacity to facilitate its purchases of residential real property. Consequently, the home leasing company obtains title to the selected residential real property before the lease term starts. At block 416, the home leasing company starts leasing the selected residential real property to the consumer. Once the consumer moves into the selected residential real property, the consumer may be allowed to update or remodel the residential real property upon approval from the home leasing company. Further, the consumer may be required to insure the property as appropriate. The routine 400 complete at block 418.

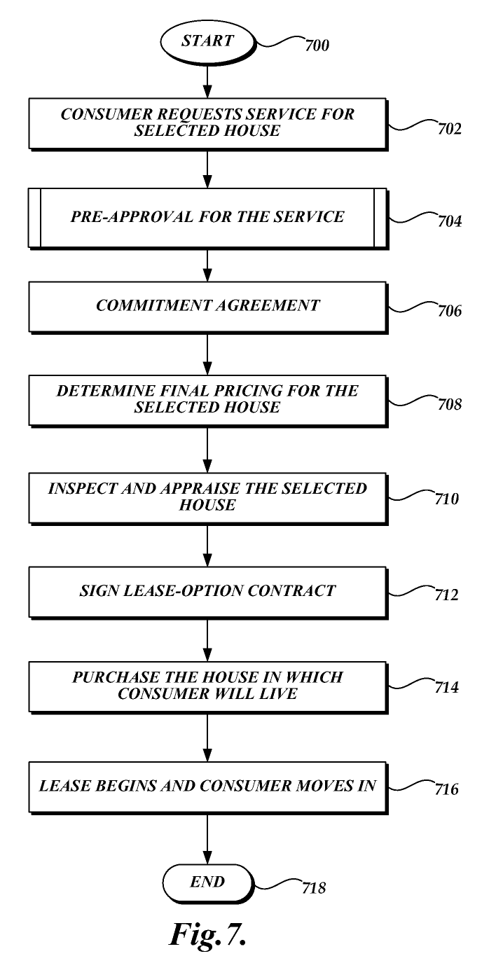

Referring to FIG. 5, a flow diagram depicts a pre-approval subroutine 500 which is utilized by the routine in FIGS. 4 and 7. For the purpose of discussion, assume that the consumer has contacted a broker and a direct salesperson for the “equity leasing” service and the broker is to communicate with the home leasing company for getting a pre-approval.

Beginning at block 502, the broker may collect information about the consumer. Some information may be obtained directly from the consumer and other information may be obtained from the service server 110. The consumer may provide information such as a name, address, current salary, date of birth, social security number, number of years of employment, employee information, a desired geographic area, desired characteristics of a residential real property, or the like.

At block 504, if necessary, the broker may obtain user profile information from the service server 110. As mentioned above, the service server 110 may include a local database to store information about existing or past consumers. If the consumer has received services from the home leasing company, previous history information about the consumer may be retrieved from the service server 110. In some instances, the home leasing company may maintain an internal consumer scoring system based on the previous history. If the consumer promptly paid a monthly payment, a consumer score will be higher than those of other consumers who did not promptly pay a monthly payment. If the consumer has previously exercised a purchase option for a leased residential real property, the consumer score will be higher than those of other consumers who are new to the service. Further, maintenance history information may be stored and reflected on the consumer score.

In some instances, the service server 110 may contact other service providers to obtain information relevant to determine an appropriate program for the consumer. For example, a credit score and/or a credit report of the consumer may be obtained from several credit reporting companies.

At block 506, the broker may determine an appropriate program for the consumer with assistance from the service server 110. In one embodiment, the broker may enter the obtained information via a user interface provided by the service server 110 in order to get a projected lease factor and appreciation factor. The lease factor and the appreciation factor may be the information transmitted from the home leasing company to brokers regarding establishing price and communicating to consumers. For example, the lease factor is a proprietary representation as to the calculation of the cost of the program (e.g., monthly lease payment) as an alternative to interest rates. Thus, the lease factor may be “tuned” based on the credit score of the consumer. It is to be noted that the monthly lease payment can be changed based on the source of funds to purchase the selected residential real property and various risk factors in the marketplace. In addition, marketing requirements or plans for a certain geographic area may be considered to determine the monthly lease payment. The appreciation factor, a proprietary calculation, may be determined based on an analysis of a local market and publicly available statistics such as the Office of Federal Housing Enterprise Oversight (OFHEO) Housing Price Index, etc. As will be discussed in greater detail below, the appreciation factor may also be used to calculate the residual purchase price for the selected residential real property.

At block 508, the determined program may be presented and explained to the consumer either directly through the server or via communication from the broker. At block 510, after the consumer and the broker agreed on the program, the agreed program is subsequently submitted to the home leasing company for issuing a pre-approval. The home leasing company reviews the program and makes a decision. In one embodiment, the home leasing company utilizes the service server 110 for an automatic or a semi-automatic decision on such pre-approval. In this embodiment, the broker submits the agreed program to the service server 110 to get a pre-approval. The service server 110 may automatically determine whether the submitted program is to be pre-approved based on rules and criteria which have been previously defined by the home leasing company. In some instances, after the service server 110 makes a decision about the submitted program, a human administrator may review the decision to enhance accuracy. The subroutine 500 returns the conditional approval (e.g., pre-approval) for the consumer and completes at block 512.

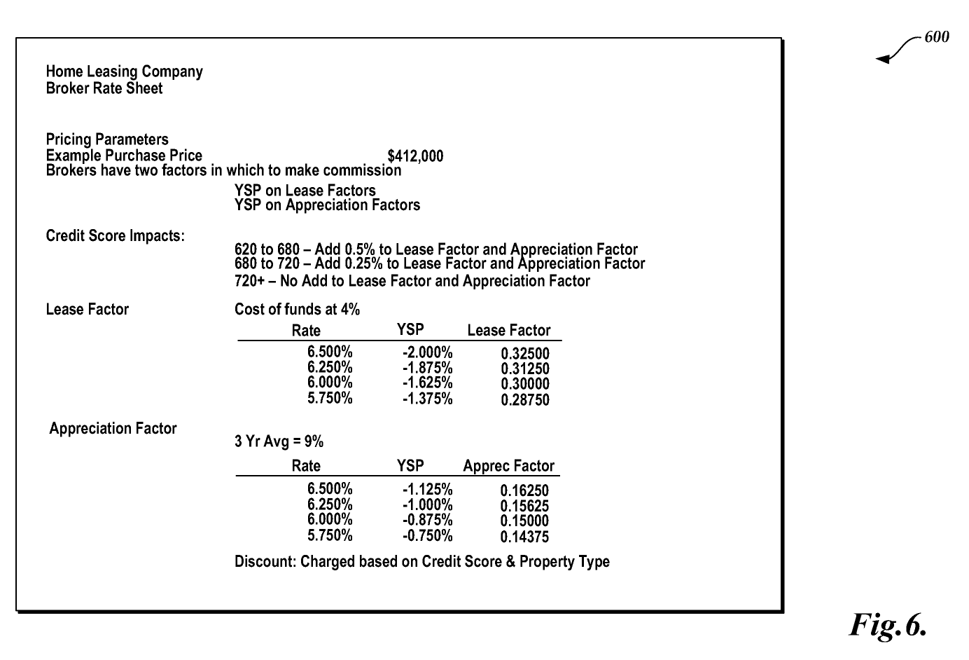

Referring to FIG. 6, an exemplary table 600 is shown, illustrating a basic rate sheet that may be utilized by a broker or sales personnel in determining an appropriate program and program pricing for the consumer, in accordance with an embodiment of the present invention. It is to be understood that rate sheets are updated on a periodic basis and distributed throughout the mortgage brokerage sales base. Program rate sheets are utilized to enable mortgage brokers to qualify applicants and price the product according to credit score and other qualifying factors as well as help the brokers determine their compensation for working with the consumer. The service server 110 may be used to enable mortgage brokers to submit applicants for approval and lock in pricing for the program. Program rate sheets are made available to brokers through the service server 110 or by request through traditional means of email and fax. The home leasing company (or underwriters) then reviews applicant submissions for approval. Lease documents and purchase documents are then generated to consummate the transactions related to the “equity leasing” service. Such documents may be generated from the service server 110 and made available for processing (signatures, etc.) through the electronic system.

As shown, the exemplary purchase price is assumed to be $412,000 for the purpose of discussion. A credit score of the consumer may also impact the lease factor and the appreciation factor. For example, the consumer's credit score may be categorized to calculate an accurate lease factor and appreciation factor. As mentioned above, the lease factors are used to communicate the pricing to the market versus interest rates so direct mortgage comparisons are not immediately apparent. If the credit score is within a range of 620-680, lease factor and the appreciation factor may be increased by 0.5% considering some risk of default. If the credit score is within a range of 680-720, the lease factor and the appreciation factor may be increased by 0.25% considering a low risk of default. Likewise, if the credit score is above 720, the lease factor and the appreciation factor may not be changed considering a very low risk of default. The appreciation factor may also be determined based on average appreciation statistics from services such as the OFHEO about the area of the selected residential real property. For example, the appreciation factor may be determined based on the average appreciation for the area for the last three years. Some characteristics of the selected property may impact the lease factor and the appreciation factor. For example, if the residential real property is a newly constructed residential real property, some discount may be available. Other characteristics of the residential real property may affect the appreciation factor, including, but not limited to, the year of structure, flood plan, earthquake zone, condition of the property, etc.

In one embodiment, monthly lease payments are purposefully determined based on a below market interest rate, for example, 4.5% interest (compare to 6.0% market interest). In this manner, the lessee can have an affordable monthly payment for the lease term and thus may be able to save more money during the lease for living expenses, to invest or to pay down debt. The residual value may be determined based on the acquisition cost, plus an appreciation factor based on lease terms and qualifications of the lessee and property characteristics.

A residual purchase price that includes determining a projected house price and monthly payments is generally based on statistical measures such as appreciation factors, leasing factors, future value of the property, interest rates, etc. In one embodiment, this pricing may be determined with a consideration of a base for appreciation on residential real property. This number is generally dependent on historically positive appreciation rates. However, it is to be noted that the “equity leasing” services are not dependent upon an appreciating market. Of course, in appreciating markets, it is true that higher than targeted margins are realized through greater residual values in the residual purchase pricing. In flat markets or declining markets, the home leasing company may continue to realize its transactional revenue base and affiliated service income. In flat or declining markets, residual values stated in lease contracts may not match property appraisals. In such cases, the lessee has three alternatives: the lessee can turn the home back to the home leasing company; the lessee can pay cash for the difference between appraised value and the residual value or the home leasing company may offer to finance the home directly to the lessee through alternative take-out financing.

Referring to FIG. 7, a flow diagram depicts another routine for an alternative financing service for purchasing a residential real property in accordance with an embodiment of the present invention. As with FIG. 4, assume that the service server 110, connected with a local or remote database and other service providers, assists the home leasing company to provide various services to several consumers. Although a consumer has a freedom to choose, consider a scenario where based on information about the consumer, a residential real property to lease may be selected by the home leasing company from a group of residential real properties available for the “equity leasing” service. The consumer may be entitled to some discounts if the residential real property is selected by the home leasing company and made available to selected consumers. Alternatively, the consumer may have already selected a home and committed to a purchase contract, but wishes to use the “equity leasing” service as an alternative to a traditional mortgage.

Beginning with block 702, a consumer may request an “equity leasing” service to a broker or a direct salesperson of the home leasing company. At block 704, a broker may communicate with the home leasing company (an underwriter, etc.) to obtain a pre-approval via subroutine in FIG. 5. The pre-approval is about a residential real property which is selected for the consumer or alternatively by the consumer. Before obtaining the pre-approval, the consumer may be informed about the selected residential real property and agree on the selected residential real property. The broker may utilize the service server 110 to select a residential real property for a particular consumer. At block 706, based on the pre-approval, the consumer may sign a commitment agreement for leasing the selected residential real property. As with FIG. 4, the pre-approval is determined by reviewing a program which the broker generally tailors for the consumer and the selected residential real property. In this case, the service server (e.g., the evaluation module) may assist the broker to determine an appropriate program for a particular consumer. The home leasing company may have predefined guidelines and rules to determine an appropriate program. A typical program may specify financial requirements, a market price of the selected residential real property, estimated lease payment, lease term, etc. At block 708, the home leasing company may further review the selected residential real property to determine the final price for the lease contract. While the home leasing company is reviewing the selected residential real property and determining the various terms and conditions for the lease contract, at block 710, the home leasing company has the selected residential real property inspected by a qualified home inspector and appraised by a licensed residential real property appraiser to conclude the value of the home. The home inspector completes the property maintenance plan that is a part of the lease contract.

At block 712, the home leasing company and the consumer may sign a lease contract on the selected residential real property. As mentioned above, the lease contract, similar to a conventional lease contract, may specify various terms, including, but not limited to, a lease term, maintenance schedule, the residual purchase price for the residential real property, projected appreciation, a remedy for a breach of contract, responsibilities of the lessee, and the like. In one embodiment, based on the housing market and the geographic area conditions, the lease term may be determined so that the home leasing company can maintain lower vacancy losses. Having each consumer responsible for maintenance of the leased residential real property, the leased residential real property can be maintained as if the consumer owns the property. At block 714, the home leasing company purchases the selected residential real property in which to allow the consumer to live. In order to fund the purchase, the home leasing company may get an appraisal on the property. Further, the home leasing company may hire a third-party home inspection company to inspect the property before acquisition. At block 716, after obtaining a title of the selected residential real property, the home leasing company starts leasing the selected residential real property to the consumer. If the selected residential real property is currently owned by the home leasing company (thus, the home leasing company does not have to purchase the residential real property), the home leasing company starts leasing the selected residential real property to the consumer after the step 712. The routine 700 completes at block 718.

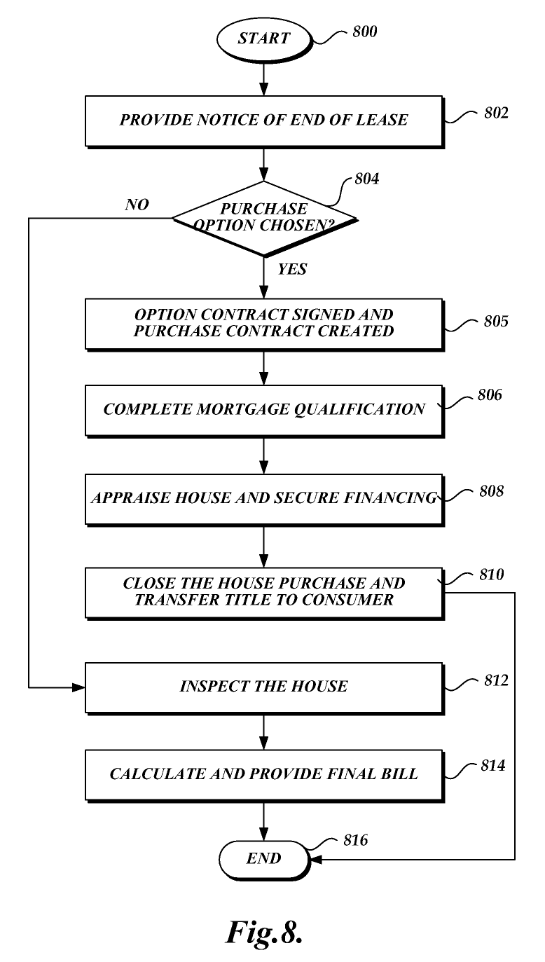

Referring to FIG. 8, a flow diagram depicts a routine 800 for allowing a consumer to exercise the options set forth in the lease contract for a leased residential real property in accordance with an embodiment of the present invention.

As with FIGS. 4 and 7, assume that the consumer has moved into the selected residential real property, which is currently owned by the home leasing company. Further, the consumer and the home leasing company have signed a lease contract which specifies when and under what conditions the consumer may end the lease or are able to purchase the home for the residual purchase price. For example, several triggering events for offering the property for purchase may be specified in the lease contract. One triggering event may be an end of the lease term or a certain achieved valuation of the property. The service server 110 may be configured to notify the consumer a few months before the end of the lease term, reminding the consumer of the end of lease options.

At block 802, at some point during the lease term, a consumer may be informed about their end of lease options which includes the option to purchase the leased residential real property. Typically, the consumer is notified of their options a few months before the end of the lease term. The consumer may accept to exercise the purchase option or decline to exercise the purchase option or possibly re-lease the residential real property. At decision block 804, a determination is made as to whether the consumer chooses which of these three methods they wish to choose. If the consumer chooses to purchase the residential real property with a residual price, at block 805 the consumer signs an option contract and a purchase contract is created.

At block 806, the home leasing company reviews the consumer's mortgage qualification. A third party mortgage company may appraise the residential real property and the consumer may secure financing to purchase the residential real property through the third party mortgage company. Alternatively, permanent financing may be offered by the home leasing company or one of its affiliates. At block 810, the home leasing company closes the purchase for residential real property and transfers the title to the consumer.

If the consumer chooses to move out of the residential real property under lease, the home leasing company inspects the residential real property before the end of the lease term as illustrated at block 812. Preferably, a final inspection may be conducted by the same home inspection company that inspected the property at acquisition. Fees may be charged for excessive wear and maintenance left incomplete. In one embodiment, the home leasing company may update the consumer's credit score and user profile information. Further, the home leasing company may report to credit reporting service providers to ensure a higher degree of response to its final bill. At block 814, the final bill may be calculated and provided to the consumer. After the consumer moves out, the residential real property is then readied to enter a real estate market as for sale or lease. In one embodiment, the consumer can choose to re-lease the residential real property at the end of the lease term. In that embodiment, terms are presented for a lease extension that would include a modification to the monthly lease payment, residual purchase price and other such terms in the lease contract. An updated review of the consumer's qualifications may be conducted by underwriting or through input to the service server 110. A modified lease would be completed and signed by the consumer prior to the end of the existing lease. The routine 800 completes at block 816.

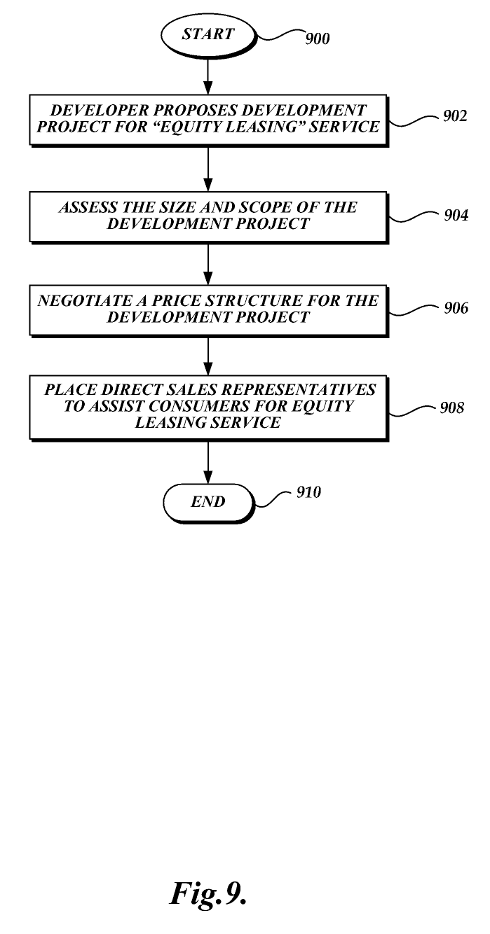

Referring to FIG. 9, a flow diagram depicts a routine for facilitating an alternative financing service in accordance with an embodiment of the present invention. For purpose of discussion, the service server 110, connected with local or remote databases and other service providers via a data network, assists the home leasing company to provide “equity leasing” services to residential real estate development customers.

Beginning with block 902, a broker or direct sales person representing the home leasing company may contact or be contacted by a residential real property development company that wishes to utilize the home leasing company to finance or help the sales of one or more development projects. At block 904, an assessment is made of the size and scope of the development project(s). This assessment may include the number of units, the price, type of construction, location, timing of the project, etc. Generally, the direct sales person would discuss the details with representatives of the development project and may conduct a site visit. After the direct sales person completes the assessment, at block 906, the developer would negotiate a discounted price structure on its inventory to accommodate the bulk sales to the home leasing company. This information would then be input by the direct sales person via the service server 110 to update the home selection module reflecting lease pricing for the development. The consumer may then be able to access the available inventory from the development project from the service server 110 along with the specific pricing. At block 908, specific direct sales representatives may be located on development sites or via direct communication to meet with consumers and assist them in the application process as depicted in FIG. 7.

For larger developments a joint venture may be created between the home leasing company and the development company. This joint venture would specify the terms of the relationship between the development company and the home leasing company. Discounted pricing may be negotiated along with profit sharing. In this manner, the development company would act as a program investor and would finance the initial purchase of the residential real property as described in FIG. 2. The home leasing company would maintain its role as the operator of the program and manage the program. This joint venture may continue through one or many developments. Once the joint venture is agreed to, the program details are input into the service server 110 and pricing is posted to the home selection module and made available to consumers.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for providing a service which enables a consumer to lease a residential real property with a residual purchase option, the method comprising:
allowing a consumer to select a residential real property for the service;
receiving, from the consumer, information about the selected residential real property for the service;
evaluating the information about the selected residential real property in order to determine a financing and purchasing decision;
obtaining from the consumer an agreement with respect to the selected residential real property, the agreement specifying terms and conditions for the service;
upon receipt of the agreement, purchasing the selected residential real property in which to allow the consumer to live; and
at any triggering events for a purchase option, offering to the consumer the purchase option for the selected residential real property.

2. The method of claim 1, further comprising:
upon receipt of acceptance of the purchase option offer, finalizing a purchase of the selected residential real property and transferring a title of the selected residential real property to the consumer.

3. The method of claim 1, further comprising:
receiving a request for the service to lease a residential real property.

4. The method of claim 1, wherein allowing a consumer to select residential real property includes:
obtaining user profile information;
determining a proper program for the consumer based on the user profile information, the proper program including credit limits and recommendations; and
providing the consumer with the proper program.

5. The method of claim 4, wherein the proper program includes a set of criteria for the consumer to select a residential real property.

6. The method of claim 4, wherein the user profile information includes previous history, credit score, and financial status of the consumer.

7. The method of claim 6, wherein the agreement further specifies a set of conditions of the triggering events.

8. The method of claim 7, wherein one condition of the triggering events is a predetermined lease term.

9. The method of claim 7, wherein one condition of the triggering events is a market price of the selected residential real property.

10. The method of claim 6, wherein the agreement further specifies a monthly payment and a residual value of the selected residential real property.

11. The method of claim 10, wherein the residual value of the selected residential real property is determined based on an appreciation factor, a lease factor and the user profile information.

12. The method of claim 11, wherein the appreciation factor is determined based on the user profile information and an average appreciation for an area where the selected resident real property is located.

13. The method of claim 11, wherein the lease factor is determined based on a market interest rate.

14. The method of claim 1, wherein the financing decision is determined after obtaining a pre-approval from a third party financing company.

15. The method of claim 1, wherein the financing decision is determined after obtaining a pre-approval through a home leasing company.

16. The method of claim 1, wherein the residential real property includes a single family house, an apartment, a condominium, and a townhouse.

17. The method of claim 1, wherein offering a purchase option for the residential real property includes re-obtaining and reviewing the user profile information of the consumer.

18. The method of claim 17, further comprising:
evaluating a residual purchase price of the residential real property based on the agreement and reflecting the evaluation to the purchase option.

19. The method of claim 1, wherein the selected residential real property is chosen from a pool of residential real properties which are provided by an affiliated developer.

20. The method of claim 1, wherein the pool of residential real properties are planned and built for the service.

21. An alternative financing service system for allowing a consumer to purchase a residential real property with a residual purchase option price, the residential real property being leased to the consumer, the alternative financing service system comprising:
a broker component for receiving a request for a service from a consumer, and for receiving, from the consumer, information about a selected residential real property for the service;
an evaluation component for evaluating the information about the selected residential real property in order to determine a financing and purchasing decision; and
a decision component for determining a purchasing and financing decision and for preparing a service agreement, the agreement specifying terms and conditions for the service.

22. The alternative financing service system of claim 21, wherein when the decision component detects a triggering event, the decision component notifies the customer of a purchase option for the selected residential real property.

23. The alternative financing service system of claim 21, further comprising an information retrieval component for obtaining user profile information and a set of rules and criteria for the service.

24. The alternative financing service system of claim 23, wherein the broker component determines and provides a proper program for the consumer based on the user profile information and the set of rules and criteria.

25. The alternative financing service system of claim 24, wherein the broker component utilizes existing residential mortgage channels.

26. The alternative financing service system of claim 24, wherein the proper program includes a recommendation about an area and a type of a residential real property.

27. The alternative financing service system of claim 20, wherein the service agreement further specifies a set of conditions of the triggering events.

28. The alternative financing service system of claim 20, further comprising analyzing a current real property market for determining the purchasing decision.

29. A computer implemented method for providing a service which allows a consumer to select a residential real property for an equity leasing service provided by a home leasing company wherein the equity leasing service locks a residual purchase price for a future purchase of the residential real property, the computer implemented method comprising:
approving a financing program for the consumer, the program including preliminary terms and conditions for the consumer to have the equity leasing service;
allowing the consumer to select a residential real property, the residential real property being selected based on the approved financing program;
evaluating information about the selected residential real property in order to determine a financing and purchasing decision;
obtaining from the consumer an agreement on the leasing the selected residential real property for a lease term;
upon receipt of the agreement, purchasing the selected residential real property in which to allow the consumer to live; and
at any triggering events for a purchase option, enabling the consumer to purchase the selected residential real property at a residual purchase option price,
wherein the residual purchase option price and the triggering events are specified in the agreement.

30. The computer implemented method of claim 29, wherein if the consumer wants to purchase the selected residential real property, the home leasing company assist the consumer to finalize a purchase of the selected residential real property.

31. The computer implemented method of claim 30, wherein the home leasing company assists the consumer to get a mortgage for the purchase of the selected residential real property.

32. The computer implemented method of claim 29, wherein approving a financing program includes:
obtaining user profile information;
determining the financing program for the consumer based on the user profile information; and
negotiating with the consumer on the determined financing program.

33. The computer implemented method of claim 32, wherein the financing program includes a set of criteria for the consumer to select a residential real property.

34. The computer implemented method of claim 26, wherein the residual purchase option price is projected based on an appreciation factor, a lease factor and the user profile information.

35. The computer implemented method of claim 31, wherein the appreciation factor is determined based on the user profile information and an average appreciation for an area where the selected resident real property is located.

36. The computer implemented method of claim 32, wherein the lease factor is determined based on a market interest rate.

37. The computer implemented method of claim 29, wherein the selected residential real property is chosen from a pool of residential real properties which are provided by an affiliated developer.
